(19) United States
(12) Patent Application Publication
(10) Pub. No.: US 2019/0170452 A1
(43) Pub. Date: Jun. 6, 2019

(54) HEATING OR AIR CONDITIONING SYSTEM

(71) Applicant: MAHLE International GmbH, Stuttgat (DE)

(72) Inventors: Juergen HEILEMANN, Wendlingen (DE); Elke DETTLING, Asperg (DE); Jeetendra Ashwinikumar KALE, Satara (IN)

(73) Assignee: MAHLE International GmbH, Stuttgart (DE)

(21) Appl. No.: 16/208,839

(22) Filed: Dec. 4, 2018

(30) Foreign Application Priority Data
Dec. 4, 2017 (DE) 10 2017 221 771.5

(51) Int. Cl. F28F 9/00; B60H 1/00

(52) U.S. Cl. CPC F28F 9/005; B60H 1/00521; F28F 2275/12; F28F 2280/08; F28F 2230/00

(57) ABSTRACT

A heating or air conditioning system with a housing and with a heat exchanger located therein, wherein the housing constitutes an upper housing part and a lower housing part in which the heat exchanger is positioned, and the upper housing part forms, in the region where the heat exchanger is positioned, a housing wall that the heat exchanger is in direct contact with. The housing wall is designed to be elastic, at least in sections, such that the housing wall elastically yields in the contact region of the heat exchanger to compensate for dimensional tolerances of the heat exchanger.

This nonprovisional application claims priority under 35 U.S.C. § 119(a) to German Patent Application No. 10 2017 221 771.5, which was filed in Germany on Dec. 4, 2017, and which is herein incorporated by reference.

### BACKGROUND OF THE INVENTION

### Field of the Invention

The present invention relates to a heating or air conditioning system with a housing with at least one heat exchanger located therein.

### Description of the Background Art

In heating or air conditioning systems, at least one heat exchanger is installed in order to control the temperature of the air flowing through the housing and also, if applicable, to dehumidify it, etc. To this end, the heat exchanger is or the heat exchangers are securely mounted in the housing, typically between a lower housing part and an upper housing part, so that they do not shake in the housing and generate noises when vibrations occur. However, the heat exchangers have a relatively large tolerance, particularly in their height direction, also referred to as the z-direction, so that the variation in the height of the heat exchangers can be relatively great from heat exchanger to heat exchanger. In this context, the housing is divided into a lower housing part and an upper housing part, which are placed one on top of the other after the heat exchanger has been inserted, and then are closed.

In the prior art, in order to be able to position such heat exchangers tightly in the housing and fasten them regardless of their actual extent in the height direction, foam or EPDM seals are provided on the top and on the bottom of the heat exchanger that are compressed to a greater or lesser degree depending on the actual height of the heat exchanger in order to place the heat exchanger against the housing, in particular against the upper housing part on the top and, if applicable also against the lower housing part on the bottom so that the heat exchanger is in tight contact with the housing.

Also known are inwardly projecting ribs of elastic design on the upper housing part, which are bent to a greater or lesser degree by the heat exchanger depending on its individual height, in order to achieve the tight positioning of the heat exchanger in the housing.

Costs are increased undesirably through the use of foam or EPDM seals, with the provision of the additional ribs on the housing also incurring additional costs, which it is desirable to avoid, especially in heating or air conditioning systems of motor vehicles.

### SUMMARY OF THE INVENTION

It is therefore an object of the present invention to provide a heating or air conditioning system that is equipped with a housing and at least one heat exchanger therein, and that can be manufactured simply and economically.

In an exemplary embodiment of the invention, a heating or air conditioning system is provided with a housing and with a heat exchanger located therein, wherein the housing constitutes an upper housing part and a lower housing part in which the heat exchanger is positioned, and the upper housing part forms, in the region where the heat exchanger is positioned, a housing wall that the heat exchanger is in direct contact with, wherein the housing wall is designed to be elastic, at least in sections, such that the housing wall elastically yields in the contact region of the heat exchanger to compensate for dimensional tolerances of the heat exchanger. This achieves the result that no additional sealing materials must be provided at the heat exchanger, nor are any additional ribs required to support the heat exchanger in the housing in a stable manner, so costs can be saved in this regard.

It is advantageous when the housing wall forms, in the contact region of the heat exchanger, a seat region that is connected to the adjoining housing wall by at least one region of reduced wall thickness. In this way, the seat region is designed to be elastically displaceable so that it can compensate for tolerances of the heat exchanger. The region of reduced wall thickness serves here as an elastic element that, on the one hand, connects the seat region to the adjoining housing wall and on the other hand allows the seat region to be displaced relative to the adjoining housing wall. Advantageously, the seat region, the region of reduced wall thickness, and the adjoining housing wall are made as a single piece, in particular of plastic, and by injection molding.

The seat region can be essentially flat in design. As a result, the heat exchanger can be placed well on the seat region, and a force can be introduced uniformly to hold the heat exchanger.

The seat region can be a planar region that is surrounded, at least partially or completely, by the at least one region of reduced wall thickness. This achieves the result that the planar seat region can be displaced elastically relative to the adjoining housing wall without local stress concentrations arising.

The seat region can be a planar region that is surrounded, at least partially or completely, by multiple regions of reduced wall thickness. As a result, the displacement can be distributed over multiple regions of reduced wall thickness that accomplish the elastic displacement.

It is also useful when the region of reduced wall thickness connects the seat region to the adjoining housing wall in the manner of a bellows or a film hinge. In this way, a defined flexibility of the seat region is achieved to securely support the heat exchanger.

The seat region can be designed to be offset relative to the adjoining housing wall in the unstressed state. As a result, the seat region can be offset toward the interior of the housing so that when the heat exchanger is inserted, it displaces the seat region in opposition to the restoring force of the region of reduced wall thickness in order to achieve a preloading.

The seat region can bes displaceable relative to the adjoining housing wall in a direction perpendicular to the plane of the seat region. As a result, the preloading of the seat region is achieved so as to be able to hold the heat exchanger in place.

It is useful when the seat region is preloaded toward the interior of the housing in the unstressed state. This achieves the result that the heat exchanger displaces the seat region, and thus is securely held.

The housing wall with the region of reduced wall thickness and with the seat region can be made of a plastic. Assembly costs can be saved through the integrated design.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic representation of a heating or air conditioning system according to an exemplary embodiment of the invention; and

FIG. 2 is, in a left-hand image, a schematic sectional view of a housing wall in the contact region of a first heat exchanger with a seat region, and in the right-hand image a second, somewhat larger heat exchanger with a seat region.

### DETAILED DESCRIPTION

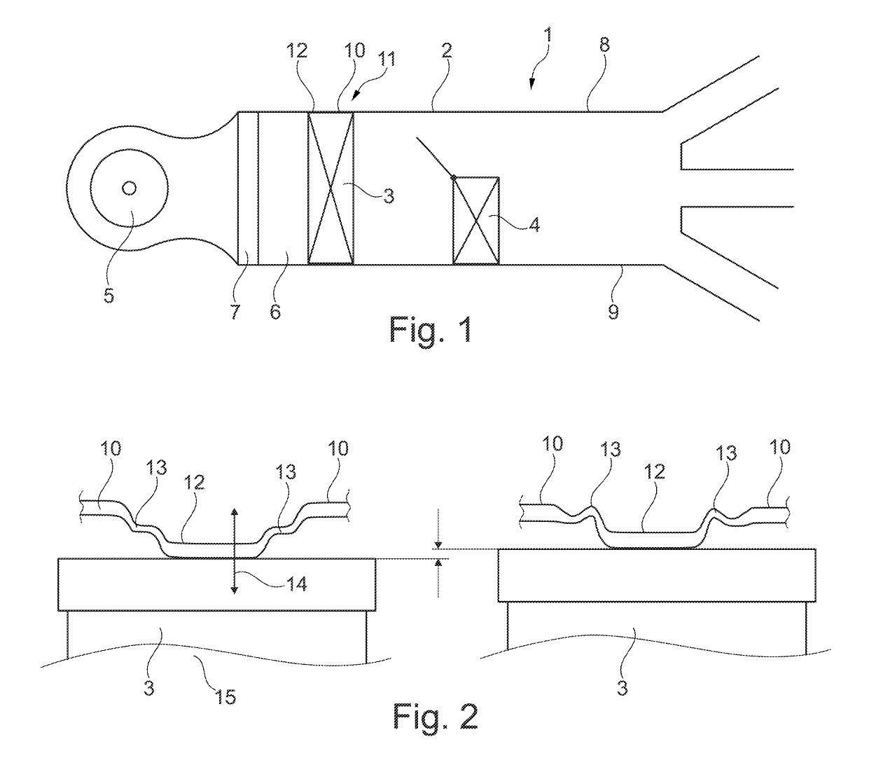

FIG. 1 shows a schematic representation of a heating or air conditioning system 1 with a housing 2 and with a heat exchanger 3 located in the housing 2. In this design, the heat exchanger 3 in the housing 2 is designed as an evaporator, and an additional heat exchanger 4 is also provided as a heater. The heating or air conditioning system 1 also has a fan 5 that draws in air and directs it into the air duct 6. Also provided in the air duct 6 is a filter 7 for filtering the air.

The housing 2 in this design has an upper housing part 8 and a lower housing part 9, wherein the heat exchanger 3 is positioned in the housing between the lower housing part 9 and the upper housing part 8. The upper housing part 8 forms, in the region where the heat exchanger 3 is positioned, a housing wall 10 that the heat exchanger 3 is in direct contact with.

The housing wall 10 can be designed to be elastic, at least in sections, such that the housing wall 10 elastically yields in the contact region 11 of the heat exchanger 3 to compensate for dimensional tolerances of the heat exchanger 3.

In this design, the housing wall 10 forms, in the contact region 11 of the heat exchanger 3, a seat region 12 that is connected to the adjoining housing wall 10 by at least one region of reduced wall thickness 13. This is shown in FIG. 2. The seat region 12 with which the heat exchanger 3 is in contact is connected to the adjacent housing wall 10 by the applicable region of reduced wall thickness 13.

It is also evident in FIG. 2 that the seat region 12 is essentially flat in design. Advantageously, the seat region 12 is a planar region that is at least partially or completely surrounded by the at least one region of reduced wall thickness 13. Preferably, the region of reduced wall thickness 13 surrounds the seat region 12 completely, for example in a rectangular or circular or oval shape.

It is also advantageous in this design when the seat region 12 is a planar region that is at least partially or completely surrounded by multiple regions of reduced wall thickness 13. In this way, the regions of reduced wall thickness 13 can permit a greater travel or displaceability of the seat region 12.

Thus, the region of reduced wall thickness 13 can connect the seat region 12 to the adjoining housing wall 10 in the manner of a bellows or a film hinge.

It is also advantageous when the seat region 12 is designed to be offset relative to the adjoining housing wall 10 in the unstressed state. This achieves the result that the seat region 12 is in contact with heat exchangers 3 even when they are small, whereas it is forced further outward in the case of larger heat exchangers 3. For this purpose, the seat region 12 is elastically connected or preloaded by the region of reduced wall thickness.

In the left-hand image, FIG. 2 shows a positioning of a somewhat smaller heat exchanger 3, in which the seat region 12 is in contact with the heat exchanger, wherein the seat region 12 is moved inward relative to the housing wall 10.

In the right-hand image, FIG. 2 shows a positioning of a somewhat larger heat exchanger 3, in which the seat region 12 is in contact with the heat exchanger, wherein the seat region 12 is moved somewhat further outward relative to the housing wall 10 than in the left-hand image.

FIG. 2 thus shows that the seat region 12 is displaceable relative to the adjoining housing wall 10 in a direction 14 perpendicular to the plane of the seat region 12.

It is also advantageous when the seat region 12 is preloaded toward the interior 15 of the housing 2 in the unstressed state.

The housing 2 and the housing wall 10 with the region of reduced wall thickness 13 and with the seat region 12 can be made of a plastic, such as, in particular, of polyamide, etc.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A heating or air conditioning system comprising:
a housing; and
a heat exchanger arranged in the housing,
wherein the housing has an upper housing part and a lower housing part in which the heat exchanger is positioned,
wherein the upper housing part forms, in a region where the heat exchanger is arranged, a housing wall that the heat exchanger is in direct contact with, and
wherein the housing wall is elastic, at least in sections, such that the housing wall elastically yields in a contact region of the heat exchanger to compensate for dimensional tolerances of the heat exchanger.

2. The heating or air conditioning system according to claim 1, wherein the housing wall forms, in the contact region of the heat exchanger, a seat region that is connected to the adjoining housing wall by at least one region of reduced wall thickness.

3. The heating or air conditioning system according to claim 2, wherein the seat region is essentially flat in design.

4. The heating or air conditioning system according to claim 2, wherein the seat region is a planar region that is surrounded, at least partially or completely, by the at least one region of reduced wall thickness.

5. The heating or air conditioning system according to claim 4, wherein the seat region is a planar region that is surrounded, at least partially or completely, by multiple regions of reduced wall thickness.

6. The heating or air conditioning system according to claim 2, wherein the region of reduced wall thickness connects the seat region to the adjoining housing wall in the manner of a bellows or a film hinge.

7. The heating or air conditioning system according to claim 2, wherein the seat region is offset relative to the adjoining housing wall in an unstressed state.

8. The heating or air conditioning system according to claim 2, wherein the seat region is displaceable relative to the adjoining housing wall in a direction substantially perpendicular to the plane of the seat region.

9. The heating or air conditioning system according to claim 7, wherein the seat region is preloaded in a direction toward an interior of the housing in the unstressed state.

10. The heating or air conditioning system according to claim 1, wherein the housing wall with the region of reduced wall thickness and with the seat region is made of a plastic.
